(19) United States
(12) Patent Application Publication
(10) Pub. No.: US 2012/0154971 A1
(43) Pub. Date: Jun. 21, 2012

(54) Programmable Lightning Detector

(75) Inventor: Brian Keith Brashear, San Antonio, TX (US)

(73) Assignee: ILD TECHNOLOGIES, LLC, San Antonio, TX (US)

(21) Appl. No.: 12/975,170

(22) Filed: Dec. 21, 2010

(51) Int. Cl. H02H 3/22

(52) U.S. Cl. 361/118

(57) ABSTRACT

A system and method for protecting devices and equipment from lightning strikes is disclosed. The protection device provides real-time monitoring of local atmospheric conditions to protect sensitive power-supply and control equipment. Embodiments of the device may be triggered by the detection of an actual lightning strike or an abrupt change in atmospheric charging that could indicate the presence of lightning conditions. The device provides lightning protection by isolating control, power, and signal circuits from external conductors and placing them in safe operating conditions for the duration of lightning strike event. Embodiments of the device may include onboard surge suppression in addition to lightning detection and protection. The device may be integrated into customer control equipment and is fully automatic. Without requiring operator intervention, the system restores normal operation when lightning events are no longer detected.

### TECHNICAL FIELD

Embodiments of the invention are directed, in general, to lightning detectors and, more specifically, to a programmable lightning detector that provides customized protection to one or more devices.

### BACKGROUND

A typical lightning flash lass about a quarter of a second and consists of three or four separate discharges or strokes each individually lasting a few ten-thousandths of a second. It is well known that lightning strikes can cause extensive damage to buildings and equipment. A direct lightning strike can damage structures and equipment located on the roof or exterior buildings. The lightning current can be carried inside and through a building by power, telephone, or analog or digital data lines or cables. The direct injection of lightning current can cause immense damage to electrical and electronic circuits and equipment inside a building. The energy in a lightning stroke can also induce currents in the wires and cables inside a building if the lightning is carried by pipes, conduits, or reinforcing or structural steel. Surge currents are generally less intense than the direct injection lightning currents, but can easily damage integrated circuits and sensitive components in computers, modems, electronic control circuits and telephone systems.

Lightning and surge damage can range from a temporary malfunction that does not cause any significant physical change to a permanent alteration in the physical properties of the equipment or its components, which may require repair or replacement of the equipment. Lightning damage in electrical and electronic equipment includes, for example, disabling motors or transformers so that equipment is no longer functional, vaporized transistors and integrated circuits on circuit boards, and blown fuses. Recovery from lightning damage can take time and can be expensive. Consequential damages from a lightning strike can also be expensive due to, for example, loss of business income while equipment is inoperative, cost of restoring data from backups and paper records, cost of replacing or repairing damaged equipment, cost of replacing damaged power and data cables, and the cost of replacing damaged structure.

Electronic equipment is typically designed to operate in a well-controlled electrical environment. Users typically install lightning protection, such as electrical surge-protective devices, and/or power conditioning equipment to mitigate the effects of electrical disturbances and lightning. Protection against lightning can be much less expensive than the repair or replacement of damaged equipment. Lightning protection can take several different forms, such as lightning rods or arresters that are designed to divert the surge currents to earth. Low-energy surge-protective devices or suppressors may be installed on specific equipment that is either vulnerable to damage or susceptible to upset. These traditional lightning protection devices are not adapted for the particular equipment to which they are connected, but instead simply act to absorb or deflect lightning currents.

### SUMMARY

Embodiments of the invention are directed to an in-line protection device that integrates a high-capacity transient voltage surge suppressor with real-time monitoring of local atmospheric conditions to protect sensitive power-supply and control equipment. Embodiments of the device may be triggered by the detection of an actual lightning strike or an abrupt change in atmospheric charging that could indicate the presence of lightning conditions. The device provides lightning protection by isolating control, power, and signal circuits from external conductors and placing them in safe operating conditions for the duration of lightning strike event. Embodiments of the device may include onboard surge suppression in addition to lightning detection and protection. The device may be integrated into customer control equipment and is fully automatic. Without requiring operator intervention, the system restores normal operation when lightning events are no longer detected.

### BRIEF DESCRIPTION OF THE DRAWINGS

Having thus described the invention in general terms, reference will now be made to the accompanying drawings, wherein:

FIG. 1 is a high level block diagram illustrating lightning protection system 100 according to an exemplary embodiment;

FIG. 2 is a high level block diagram illustrating the components of lightning protection circuit according to one embodiment;

FIG. 3 is a schematic diagram of the components of a lightning protection circuit according to an exemplary embodiment;

FIG. 4 is a flowchart illustrating an exemplary process 400 operating on a microcontroller for the lightning detection device; and

FIG. 5 illustrates an exemplary lightning flash timeline.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

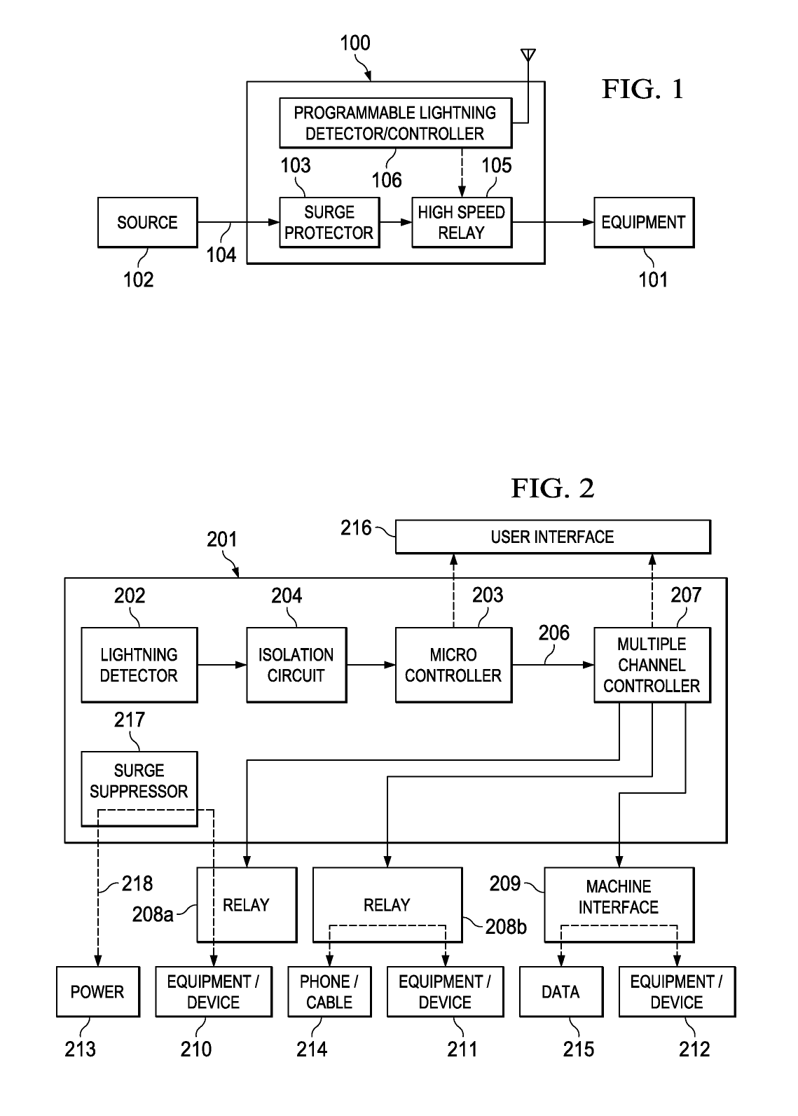

FIG. 1 is a high level block diagram illustrating lightning protection system 100 according to an exemplary embodiment. Electrical and/or electronic equipment 101 receives electrical power from source 102. Surge protector 103 protects equipment 101 from current and voltage surges that are carried on power supply line 104 from source 102 or any other origin, such as lightning strikes on cable 104. Relay 105 and lightning detector 106 provide additional protection for equipment 101 specifically in response to lightning detection. In one embodiment, lightning detector 106 includes a lightning detection circuit that detects a charge imbalance that matches a lightning profile and commands relay 105 to open. The lightning detection circuit may detect radio frequency (RF) energy generated by lightning and/or may detect any change in atmospheric charge. When relay 105 is open, equipment 101 is disconnected from power source 102 and power supply line 104. Accordingly, if lightning has occurred within detectable range, then lightning detector 106 protects equipment 101 from any current or voltage surges that would otherwise propagate along supply line 104.

It will be understood the source 102 and cable 104 are not limited to electricity distribution systems, but may be any power or data connection between equipment 101 and an external device. For example, cable 104 may be a telephone line, Ethernet or data cable, cable or closed-circuit television cable, or any other electrically conductive connection.

FIG. 2 is a high level block diagram illustrating the components of lightning protection circuit 201 according to one embodiment. The lightning protection circuit 201 comprises lightning detector circuit 202, which is coupled to microcontroller 203 through isolation circuit 204. Large electromagnetic pulses, such as those caused by lightning, are detected in circuit 202, which generates a signal at output 205 corresponding to the lightning's electromagnetic pulse. Lightning is comprised of a series of separate discharges or strokes. Lightning detector 202 generates a detection signal corresponding to each discharge or stroke. In one embodiment, the output signal at 205 is proportional in amplitude to the electromagnetic pulse created by the lightning. The duration of the detection signal corresponds to the duration of each discharge or stroke in the lightning.

Lightning detector circuit 202 is a charge balance monitoring system that detects a charge imbalance. Lightning detector 202 may detects broadband RF signals and can be tuned to specific frequencies associated with lightning.

Isolation circuit 204 isolates lightning detector 202 from microcontroller 203 to protect controller 203 from being damaged by the signals output from detector 202. In one embodiment, isolation circuit 204 optically isolates controller 203 from detector 202 so that there is no direct current path between those components.

Controller 203 receives and analyzes the output signals from detector 202. Controller 202 evaluates whether the detector output signals correlate to lightning. For example, controller 202 may analyze the relative strength, duration, and repetition interval of the detector 202 output signals and compare those parameters to one or more lightning profiles. The lightning profiles may be generated based upon observations of actual lightning as described in more detail below. Detector 202 generates a detection output signal whenever it receives an electromagnetic pulse in a certain frequency range. Interference from other devices that emit electromagnetic pulses, such as large electronic equipment, appliances, fluorescent lights and car engines, may cause detector 202 to output a detection signal that is not associated with lightning. In one embodiment, controller 203 prevents lightning protection circuit 201 from generating false lightning detections by comparing the detector output both to known lightning profiles and other known electromagnetic pulse emitters. Detector output signals that match other known, non-lightning emitters can be eliminated and not further processed by lightning detector 201.

Upon detection of lightning, controller 203 generates a control signal 206 for multiple-channel controller 207. Control signal 206 indicates to channel controller 207 that some action should be taken for one or more controlled channels. In one embodiment, multi-channel controller 207 provides control over eight different channels. However, it will be understood that controller 207 may control any number of channels, including one. In addition to indicating that lightning has been detected, control signal 206 may designate one or more particular channels for which channel controller 207 should take action. In one embodiment, channel controller 207 controls one or more relays 208 or other interfaces 209. Channel controller 207 opens or closes relays 208 or activates interface 209 upon receipt of control signal 206.

Relays 208 and interface 209 may operate to control connects between equipment 210-212 and a power line or other wire, cable, or connection. For example, relay 208a may act as a switch that couples device 210 to a power source 213, relay 208b may act as a switch that connects device 211 to a telephone line or cable television line, and interface 209 may connect device 212 to a computer or packet network 215. Typically, such switches 208-209 are closed to allow power, data, signals, or other information to flow to equipment 210-212 during normal operation. When activated by channel controller 207, relays 208 and/or interface 209 open to disconnect equipment 210-212 from power source 213 and other lines and networks 214, 215. Once disconnected, equipment 210-212 is protected from current surges caused by a lightning strike. It will be understood that equipment 210-212 may be any electrical or electronic equipment or other device that is vulnerable to lightning surge currents. It will be further understood that relay 208 and interface 209 may couple such equipment to any conductive structure.

Microcontroller 203 and/or channel controller 207 also regulate how long equipment 210-212 remains disconnected or off-line. Each individual device 210-212 can be reconnected after an independently selected duration so that the equipment can be reconnected and/or rebooted in any particular sequence or after any desired delay. Equipment 210-212 may correspond to different devices in the same system, such as different boards in an equipment rack or different components of a computer system or server. It may be necessary or preferred to reconnect, power-up, and/or reboot the components of the same system in a particular order, such as reconnecting a power supply, then reconnecting internal buses, and finally reconnecting external interfaces.

Microcontroller 203 and/or channel controller 207 may be programmed to perform such an ordered reconnection following a lightning detection disconnect. Microcontroller 203 may provide separate disconnect and connection commands to channel controller 207 for each channel or for groups of channels. A first control signal from microcontroller 203 may indicate which channel should be disconnected from a conductive element. A second control signal may indicate that the channel should be reconnected to the conductive element. Microcontroller 203 may determine when to transmit the second control signal based upon the duration of a lightning event. Alternatively, commands or signals sent from microcontroller 203 may comprise both disconnection and connection, or activation and deactivation, information. The control signals from microcontroller 203 may indicate which channel should be disconnected from a conductive element, and for how long the disconnection should last.

In one embodiment, channel controller 207 can control up to sixteen separate channels. Each channel may be coupled to a separate device, and a unique action can be designated for each device. For example, separate timing, sequential logic, delay, sensitivity, and routines may be applied to each channel.

In some embodiments, surge suppressor 217, which may be part of lightning protection circuit 201 or a separate device, provides additional protection beyond lightning protection. Surge suppressor 217 may comprise fast-acting, ceramic fuses and thermal overload metal oxide varistors (TMOV) that provide protection to equipment 210 for any current surge on line 218. Accordingly, if line 218 or power supply 213 were hit by lightning, then lightning protection circuit 201 will protect equipment 210 both by blocking the current surge at surge suppressor 217 and by disconnecting equipment 210 from line 218 using relay 208a. Alternatively, if a current surge originates at power source 213, lightning detector 202 will not observe an electromagnetic pulse and lightning protection circuit 201 will not open relay 208a. However, surge suppressor 217 will still protect equipment 210 from a current surge on line 218 even though relay 208a is not triggered.

Although only three relays/interface devices (208, 209) are shown in FIG. 2, it will be understood that any number of such devices may be controlled by lightning protection device 201. The number of relays and other interfaces that can be controlled is limited only by the capabilities of microcontroller 203 and the number of channels available on channel controller 207.

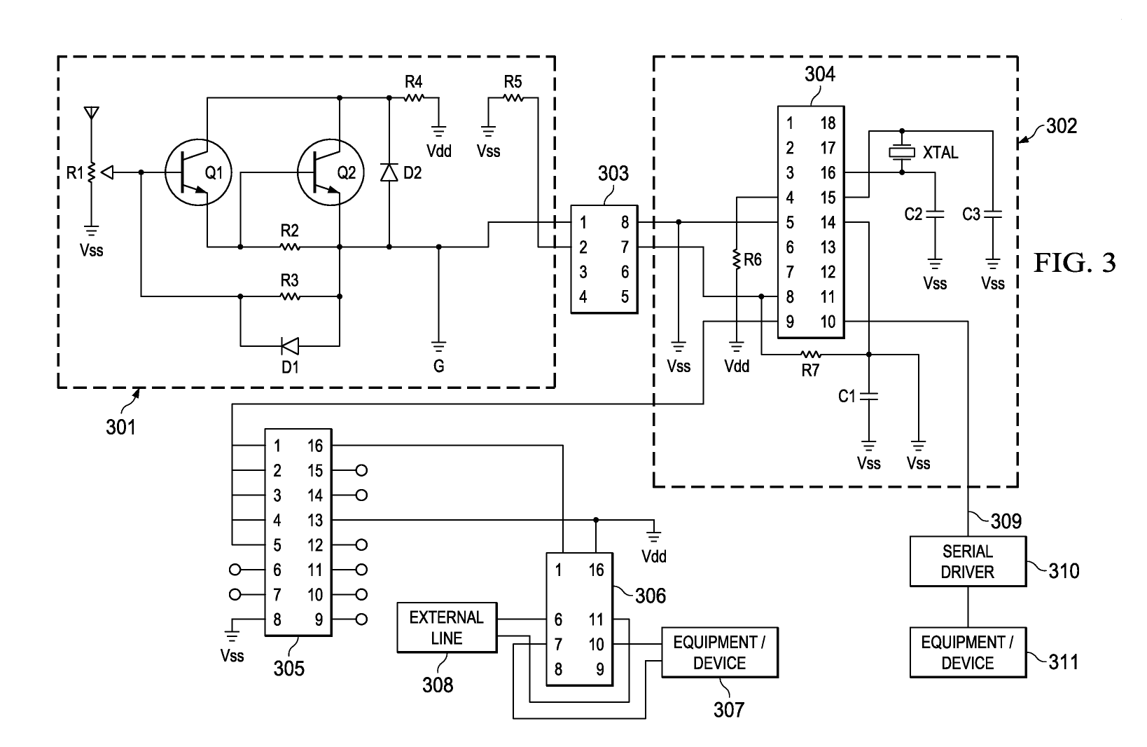

FIG. 3 is a schematic diagram of the components of a lightning protection circuit according to an exemplary embodiment. The components in section 301 form a charge balance monitoring system that operates as a lightning detector. A surface mount antenna biased by resistor R1 detects charge imbalance, such as changes in atmospheric charge caused by lightning, and generates an input pulse to the base of transistor Q1, which operates with transistor Q2 to amplify the received pulse.

The detector 301 is triggered whenever a positive charge is applied to the base of transistor Q1. The antenna may also receive RF signals that correspond to electromagnetic pulses caused by lightning. Sufficiently strong RF signals will cause a charge imbalance at the base of transistor Q1 thereby creating an output signal from the detector 301. In one embodiment, an active tuning circuit can be added to detector 301 between resistor R1 and transistor Q1. The active tuning circuit may be tuned to RF energy generated by lightning.

The electromagnetic pulses received by detector 301 are provided to microcontroller section 302 through isolation device 303, which may be an opto-isolator that prevents high currents or rapidly changing voltages in detector 301 from damaging the microcontroller 304. Isolation device 303 also adds a further level of protection to the equipment and devices 307 that are being protected. In addition to blocking current surges that are output by detector 301, isolation circuit 303 also blocks current surges that result from a direct lightning strike on the lightning protection circuit.

Section 302 includes the power supply, biasing and clock circuits for microcontroller 304, which receives and analyzes the electromagnetic pulse signals. If the signals from detector 301 correlate to a lightning pattern or signature, then microcontroller 304 outputs a signal to channel controller 305. Based upon the input signals from microcontroller 304, channel controller 305 controls relay 306, which regulates connections between equipment 307 and external lines 308.

Microcontroller 304 may also output serial data in response to lightning detection. For example, upon detection of lightning, microcontroller 304 generates serial output data on line 309. Serial driver 310 provides an interface for the serial data to external equipment or device 311, which may be network components. The serial data may provide specialized information to device 311, such as information concerning the distance, strength, or duration of detected lightning. For example, device 311 may be a processor, chip or ASIC on a network server, blade, card or interface. Instead of just disconnecting device 311 from an external connection using a relay, microcontroller 304 can “talk” directly to device 311 to notify it that a disconnection or lightning strike is imminent. This allows the protected device 311 to store data, halt or pause current processes, and/or enter a shutdown, sleep, or hibernation state to minimize the effects of potential lightning damage.

The construction and composition of the lightning detection, isolation, microcontroller, and channel controller sections are not limited to any particular embodiment, but may be constructed using generally available components. For example, in one embodiment, the following components may be used. Transistors Q1 and Q2 may be 2N3904 NPN General Purpose Amplifier devices available from Fairchild Semiconductor Corporation. Diodes D1 and D2 may be 1N914 high conductance fast diodes available from Fairchild Semiconductor Corporation. Isolation device 303 may be a MCT6 8-pin DIP dual-channel phototransistor output optocoupler available from Fairchild Semiconductor Corporation. Microcontroller 304 may be a peripheral interface controller (PIC) available from Microchip Technology Inc. A 4 MHz crystal may be used to provide a clock input for the microcontroller. Channel controller 305 may be a ULN2003AN high-voltage high-current Darlington transistor array available from Texas Instruments Incorporated. The components may be mounted in any form, such as surface mount, SOT, DIP, etc.

Some embodiments of the lightning detection and protection device may include built-in high-capacity surge suppression in addition to a high-speed circuit isolation during lightning strikes. High capacity Metal Oxide Varistors (MOV) with Thermal Overload Isolation for fire protection during surge events as well as in-line ceramic fuses to prevent over-current conditions may be used to provide surge suppression.

In other embodiments, a light, buzzer or horn may be activated by the lightning detection circuit to provide a visual and/or audible warning to a user when lightning is detected. Alternatively or additionally, a light or some other indication may provide notice to the user whether a particular circuit has been disconnected due to lightning detection. Referring to FIG. 2, user interface 216 may be a light, LED, buzzer, gauge, horn, vibrator or shaker that provides visual, audible or tactile feedback to the user indicating whether one or more circuits are connected/disconnected or active/inactive. In one embodiment, based upon the strength of received signals, the user interface may indicate that a local lightning event has been detected or is imminent or that lightning has been detected at a distance. User interface 216 may provide different levels of warning based upon a perceived distance of a lightning event.

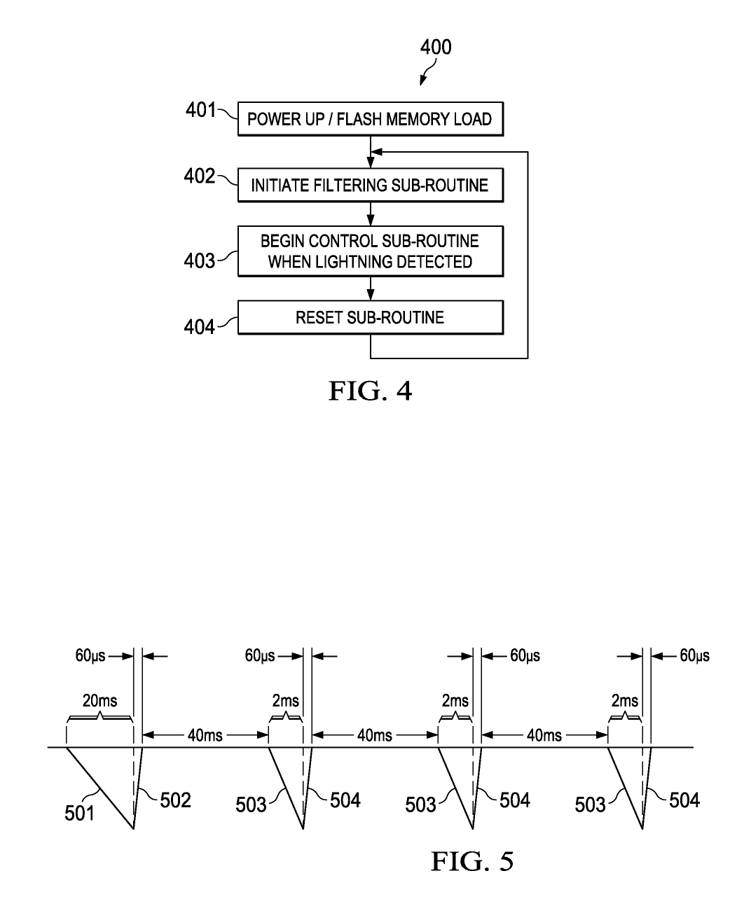

FIG. 4 is a flowchart illustrating an exemplary process 400 operating on a microcontroller for the lightning detection device. Process 400 may be embodied as software instructions running on a PIC. The software instructions may be compiled using the PICBASIC PRO complier available from microEngineering Labs, Inc. The compiled routines may run at a default clock speed, such as 4 MHz, or at faster speeds if external oscillators or clock inputs are provided to the PIC. The software instructions may be stored in the on-board flash memory of the PIC.

In step 401, the PIC powers-up and loads software instructions into on-board flash memory. In step 402, the PIC begins a filtering sub-routine during which it receives and analyzes signals from a lightning detector circuit. The filtering sub-routine compares the signals received from the lightning detector, which corresponds to electromagnetic pulses, to known lightning profiles. If the received signals match a known or expected lightning pattern, then the process moves to step 403 and begins a sub-control routine sequence. The control sub-routine regulates the channel controller to trigger relays or other interfaces to disconnect protected equipment from conductive lines. The process then moves to a reset sub-routine in step 404 in which the relays and other interfaces operate to reconnect the protected equipment to the conductive lines. The reset sub-routine may control the order and timing by which the protected equipment is reconnected to the conductive lines. For example, components of a system may be reconnected in a particular sequence and/or after a predetermined delay. The reconnection delay may be selected based upon an off/on cycle time requirement in which the protected equipment is left in a disconnected or off condition for a set period to allow components to stabilize before being reenergized.

After resetting and reconnecting the protected equipment in step 404, the process returns to step 402 where the microcontroller continues to monitor signals from the lightning detector to identify additional lightning events. Process 400 is intended to be an outline of the process for detecting lightning events and protecting equipment and devices and is not exclusive of other steps, routines, or processes that may be running concurrently with process 400. For example, diagnostics and maintenance routines may also be run by the microcontroller.

FIG. 5 illustrates an exemplary lightning flash timeline. A lightning strike comprises a series of individual discharges or strokes. Each of the strokes, which propagate from the ground up to a cloud, are preceded by a leader that propagates from the cloud to ground. The first discharge begins with a stepped leader 501 that propagates at a relatively slower rate compared to the later components of the lightning strike. A return stroke 502 follows the stepped leader 501. The stepped leader lasts approximately 20 ms, and the return stroke takes 60 μs. The subsequent strokes are separated by approximately 40 ms and are preceded by a dart leader 503. The dart leader 503 follows the path of the previous return stroke 502 and is about ten times faster than the first stroke 501. Each dart leader 503 is followed by a return stroke 504. Information concerning the composition of lightning can be found in many sources, including, for example, Martin A. Uman “Lightning,” Dover Publications, Inc. New York, 1984, the disclosure of which is hereby incorporated by reference herein. Representative values as well as a range of typical values for normal cloud to ground lightning discharges are given in Table 1 based upon information in the cited reference. It will be understood that the lightning characteristics listed herein are merely representative of typical lightning values and are not intended to represent or limit relevant lightning parameters. Typical or expected ranges for lightning parameters can be exceeded by a considerable percentage in a powerful lightning strike.

TABLE 1

| | |
|---|---|
| Representative | Potential Range |
| Values | of Values |

Stepped Leader

| | | | | |
|---|---|---|---|---|
| Time interval between steps | 50 | μs | 30-125 | μs |
| Charge deposited on stepped-leader | 5 | C | 3-20 | C |
| channel | | | | |

Dart Leader

| | | | | |
|---|---|---|---|---|
| Charge deposited on dart-leader | 1 | C | 0.2-6 | C |
| channel | | | | |

Return Stroke

| | | | | |
|---|---|---|---|---|
| Current rate of increase | 10 | kA/μs | <1->80 | kA/μs |
| Time to peak current | 2 | μs | <1-30 | μs |
| Peak Current | 10-20 | kA | −110 | kA |
| Time to half of peak current | 40 | μs | 10-250 | μs |
| Charge transferred (excluding | 2.5 | C | 0.2-20 | C |
| continuing current) | | | | |
| Energy dissipated | 100 | kJ/meter | | |

Lightning Flash

| Number of strokes per flash | 3-4 | | 1-26 | |
|---|---|---|---|---|
| Time interval between strokes | 40 | ms | 3-100 | ms |
| Time duration of flash | 0.2 | sec | 0.01-2 | s |
| Charge transferred including | 25 | C | 3-90 | C |
| continuing current | | | | |

Using the information in Table 1, or any other source of information regarding the characteristics of a lightning stroke, one or more profiles can be developed for use by the microcontroller to identify lightning and to distinguish electromagnetic pulses generated by other sources. For example, an arc welder may generate an electromagnetic pulse when it is turned on. The lightning detector may receive the electromagnetic pulse from the arc welder and send an output signal to a microcontroller. The arc welder can be distinguished from a lightning strike because it does not have the same characteristics, such as a series of very rapidly occurring pulses. Instead, the arc welder would generate a single, long electromagnetic pulse. The microcontroller would reject that pulse and would not trigger the relays or other interfaces.

The microcontroller may be programmed to recognize specific characteristics of a lightning event using, for example, one or more profiles requiring a series of electromagnetic pulses having specified frequency, pulse duration, pulse interval and/or number of pulses. Additionally, the relative strength of received electromagnetic pulses may be measured or characterized to estimate a distance of the lightning event from the detector.

The lightning detector and protection circuit described herein can be applied for use in buildings or static locations to protect against current surges that may enter equipment via fixed lines, wires or cables. In another embodiment, the lightning detector and protection circuit may be used in a mobile environment, such as in a commercial vehicle or trunk. The mobile lightning detector and protection device would give warnings to a user, such as a driver or workman at a field location. Upon detection of a lightning event, the device may also prevent operation of certain equipment on the vehicle. For example, if the vehicle was a bucket truck or scissors lift, the device may trigger a relay, interface or interlock that prevents or disables the operation of the bucket, lift, ladder or other extension apparatus. It is well known that higher objects are more exposed to lightning. This would prevent the user from being exposed to dangerous lightning conditions. In other embodiments, the device may cause a relay or other interface to lower the bucket or lift under certain high lightning threat levels conditions.

In another embodiment, the lightning detection device may be used to evaluate environmental conditions. For example, the device may be located in a remote area, such as a forest. When lightning events are detected, the device may evaluate other environmental factors, such as the temperature, humidity, and wind conditions to determine a risk of forest fire. The microcontroller may also receive such environmental data and may generate an output signal to the channel controller to trigger a warning or alert when such forest fire conditions are observed during the occurrence of a lightning event.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. A lightning detection device, comprising:
a lightning detection circuit operating to generate output signals corresponding to observed electromagnetic pulses;
a microcontroller coupled to the lightning detection circuit, the microcontroller operating to analyze the output signals from the lightning detection circuit and to identify lightning events, the microcontroller generating an output when a lightning event has been detected; and
a channel controller coupled to the microcontroller, the channel controller controlling an equipment interface to disconnect a protected device from a potential surge current source when an output is received from the microcontroller.

2. The lightning detection device of claim 1, further comprising:
an isolation circuit coupled between the lightning detection circuit and the microcontroller, the isolation circuit protecting the microcontroller from signals output from the detection circuit and from a direct lightning strike.

3. The lightning detection device of claim 1, wherein the equipment interface is a relay, the relay operating to connect and disconnect a protected device from a power line.

4. The lightning detection device of claim 1, wherein the equipment interface is a relay, the relay operating to connect and disconnect a protected device from a communication line.

5. The lightning detection device of claim 1, wherein the channel controller or the microcontroller or both control the equipment interface to reconnect the protected equipment to the potential surge current source.

6. The lightning detection device of claim 1, wherein the microprocessor further comprises one or more lightning profiles used to identify output signals from the detection device that correspond to lightning events.

7. The lightning detection device of claim 1, further comprising:
a user interface adapted to warn a user of a lightning event.

8. The lightning detection device of claim 1, wherein the equipment interface is a vehicle interlock that regulates use of an extension apparatus on the vehicle.

9. The lightning detection device of claim 1, further comprising:
a serial driver coupled to the microcontroller, the serial driver receiving serial data from the microcontroller and transmitting the serial data to a protected device.

10. A circuit for detecting lightning events, comprising a processor adapted execute software instructions, wherein the instructions, when executed, cause the processor to perform actions comprising:
receiving signals from a lightning detector circuit, the signals corresponding to detected electromagnetic pulses;
identify a group of two or more received signals that occur within a predetermined duration;
determine if the group of two or more received signals corresponds to a known lighting profile; and
generating an output signal if the group of two or more received signals does correspond to a known lighting profile.

11. The circuit of claim 10, further comprising:
a channel controller interface, wherein the output signal is transmitted to a channel controller via the channel controller interface.

12. The circuit of claim 11, wherein the output signal directs the channel controller to activate a particular interface.

13. The circuit of claim 11, wherein the output signal directs the channel controller to deactivate a particular interface.

14. The circuit of claim 11, further comprising:
a serial driver coupled to the processor, wherein the output signal is transmitted to the serial driver.

15. A method for detecting lightning events, comprising:
detecting electromagnetic pulses as radio frequency signals;
generating an output signal corresponding to the electromagnetic pulses;
comparing a series of the output signals to one or more lightning profiles;
generating a control signal, if the series of output signals corresponds to a selected lightning profile; and
triggering a device interface upon receipt of the control signal, the device interface operating to connect and disconnect a device to a conductive element.

16. The method of claim 15, wherein the device interface is a relay.

17. The method of claim 16, wherein the relay operates to connect and disconnect a device to a line, wire or cable.

18. The method of claim 15, wherein the control signal indicates a channel to be disconnected from a conductive element.

19. The method of claim 18, further comprising:
generating a second control signal, the second control signal indicating that the channel is to be reconnected to the conductive element.

20. The method of claim 18, wherein the control signal comprise disconnection and connection information, the information indicating a channel to be disconnected from a conductive element and a duration for until the channel is reconnected to the conductive element.

21. The method of claim 15, further comprising:
generating a warning to a user if the series of output signals corresponds to a selected lightning profile.

22. The method of claim 15, wherein the device interface is located on a vehicle and operates to connect and disconnect an extension apparatus from a power source.
